(19) United States
(12) Patent Application Publication
(10) Pub. No.: US 2014/0205196 A1
(43) Pub. Date: Jul. 24, 2014

(54) SYSTEM AND METHOD FOR PHOTO FRAME WITH DYNAMIC AUTOMATIC TEMPLATE BUILDING SYSTEM AND LOCATION SENSITIVE PHOTO COMMERCE

(71) Applicant: ZAAH TECHNOLOGIES, INC., Farmingdale, NY (US)

(72) Inventors: MAURICE FREEDMAN, EAST NORTHPORT, NY (US); SANDY FLIDERMAN, ALBERTSON, NY (US)

(21) Appl. No.: 13/968,557

(22) Filed: Aug. 16, 2013

Related U.S. Application Data
(60) Provisional application No. 61/684,030, filed on Aug. 16, 2012.

(51) Int. Cl. G06T 11/60

(52) U.S. Cl. CPC G06T 11/60
USPC 382/217

(57) ABSTRACT

A method is provided for photo frames with dynamic automatic template building system and location sensitive photo commerce. The method comprises: determining, by a geographic location sensing device, a first geographic location of the mobile device; obtaining, by a communication device, information from an external source regarding templates for photo frames associated with second geographic locations of known proximity to the first geographic location; downloading, by the communication device, a template for one of the photo frames for which information was received, the photo frame including a graphic content; combining, by the processor, the graphic content from the photo frame with additional graphic content from one of a digital photo stored previously stored in a memory or a digital photo taken by a digital camera; creating a new digital photo from the combined graphic content; and storing the new digital photo in the memory.

### CROSS-REFERENCE TO RELATED APPLICATIONS

This application claims benefit of U.S. Provisional Application No. 61/684,030, filed Aug. 16, 2012, entitled SYSTEM AND METHOD FOR PHOTO FRAME WITH DYNAMIC AUTOMATIC TEMPLATE BUILDING SYSTEM AND LOCATION SENSITIVE PHOTO COMMERCE (Atty. Dkt. No. VMZA-31187), the specification of which is incorporated herein by reference in its entirety.

### TECHNICAL FIELD

The invention relates to a system and method for providing graphic frame content to a mobile device that may be combined with a first digital photo to create a second digital photo that incorporates elements of both the graphic frame and the first digital photo. In particular, the invention relates to a system and method for providing graphic frame content that is automatically customized based on the geographic location of a mobile device.

### BACKGROUND

It is known to provide digital graphic content called a “photo frame” that can be combined with a first digital photo to create a second digital photo wherein all or part of the content of the first digital photo is “framed”, i.e., surrounded by, the digital graphic content of the photo frame. Such photo frames can be used to embellish or enhance the appearance of the original (i.e., first) digital photo. After creation, the second digital photo incorporating the photo frame may be stored in a memory, displayed on a screen, printed as a hard copy, or transferred to another device.

It is also known to provide a physical display device called a “digital frame” for displaying digital photos. Such digital frames typically use a LCD display screen or an LED display screen to display the digital photos from a memory. Such digital frames may sometimes be referred to as digital photo frames; however they are quite different from the graphic content photo frames previously described.

For purposes of this application, unless otherwise expressly stated, the term “photo frame” shall refer to digital graphic content that can be combined with a first digital photo to create a second digital photo, and not to the physical display device.

### SUMMARY

In one aspect of the invention, a method is provided for execution on a mobile device for photo frames with dynamic automatic template building system and location sensitive photo commerce on the mobile device. The mobile device has a processor, a touchscreen display operatively coupled to the processor, a memory operatively coupled to the processor, a communication device operatively coupled to the processor, a geographic location sensing device operatively coupled to the processor and a digital camera operatively coupled to the processor. The method comprises the following steps: determining, by a geographic location sensing device operatively coupled to a processor of a mobile device, a first geographic location of the mobile device; obtaining, by a communication device operatively coupled to the processor, information from an external source regarding templates for photo frames associated with second geographic locations of known proximity to the first geographic location; downloading, by the communication device, a template for one of the photo frames for which information was received from the external source, the photo frame including a graphic content; combining, by the processor, the graphic content from the photo frame with additional graphic content from one of a digital photo stored previously stored in a memory operatively coupled to the processor or a digital photo taken by a digital camera operatively coupled to the processor; creating a new digital photo from the combined graphic content from the photo frame and the additional graphic content; and storing the new digital photo in the memory.

In one embodiment, the information regarding templates for photo frames associated with second geographic locations is filtered to display only information regarding photo frames associated with second geographic locations within a specified distance of the first geographic location.

In another embodiment, the user of the mobile device can select the specified distance from a range of distances.

In yet another embodiment, the user of the mobile device can select the specified distance from a range of distances using a slider on a touchscreen operatively connected to the processor.

In a further embodiment, the user of the mobile device can select the specified distance from plurality of predetermined distances.

In another embodiment, the photo frame further comprises user-supplied data added to the graphic content.

In still another embodiment, the photo frame further comprises date information automatically added to the graphic content.

In yet another embodiment, the photo frame further comprises location specific photo commerce information added to the graphic content.

### BRIEF DESCRIPTION OF THE DRAWINGS

For a more complete understanding, reference is now made to the following description taken in conjunction with the accompanying Drawings in which:

FIG. 1 is a schematic drawing of a system for executing a method for photo frame with dynamic automatic template building system and location sensitive photo commerce in accordance with one aspect of the invention;

FIG. 2a shows a template for a digital photo frame including location sensitive photo commerce in accordance with one embodiment;

FIG. 2b shows a digital photo produced by combining a first digital photo with the photo frame template of FIG. 2a;

FIG. 3 is a schematic drawing of a system and method for dynamic automatic template building and location sensitive photo commerce in accordance with another aspect of the invention; and

FIGS. 4a and 4b illustrate a system for executing a method for photo frame with dynamic automatic template building and location sensitive photo commerce on a mobile device in accordance with another aspect of the invention, wherein FIG. 4a is a first portion of the flowchart and FIG. 4b is a second portion of the flowchart.

### DETAILED DESCRIPTION

Referring now to the drawings, wherein like reference numbers are used herein to designate like elements throughout, the various views and embodiments of a system and method for photo frame with dynamic automatic template building system and location sensitive photo commerce are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

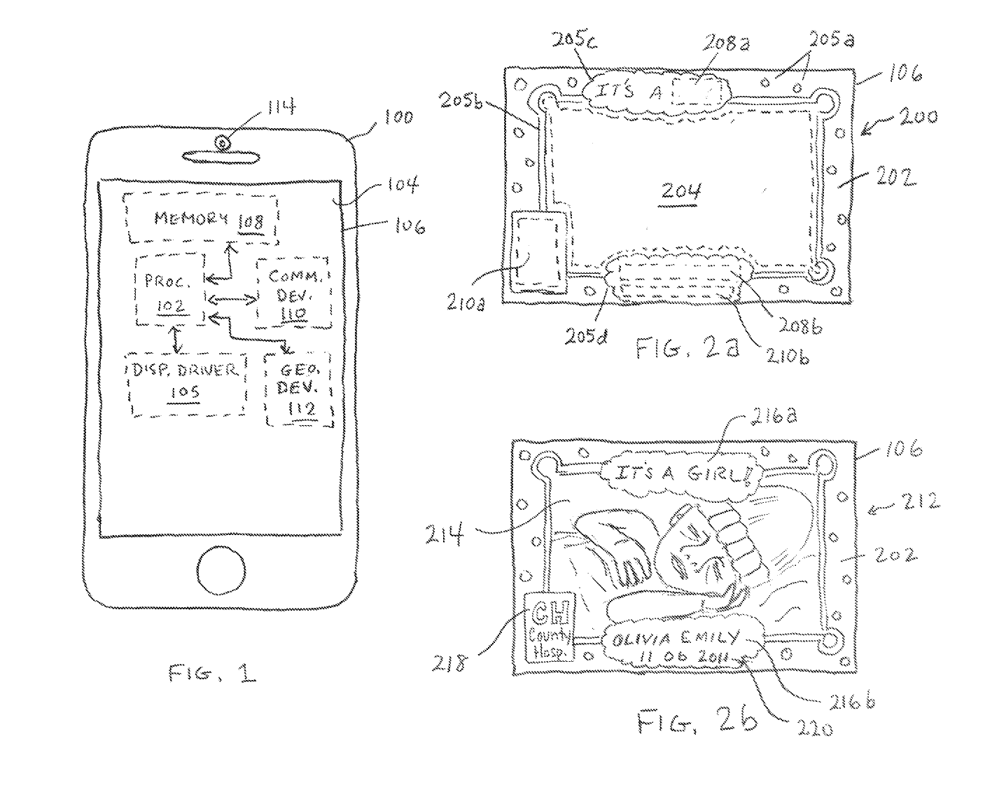

Referring now to FIG. 1, there is illustrated a system for executing a method for photo frame with dynamic automatic template building system and location sensitive photo commerce in accordance with one aspect of the invention. The system is typically executed using a mobile device 100. The mobile device 100 may be a smart phone such as an iPhone™ brand smart phone running the iOS™ brand operating system, a smart phone running the Android™ brand operating system, a smart phone running the Windows™ brand operating system, another smart phone, a tablet such as the iPad™ brand tablet running the iOS™ brand operating system, a tablet running the Android™ brand operating system, a tablet running the Windows™ brand operating system or another tablet. The mobile device 100 includes a processor 102, a touchscreen display 104 operatively coupled to the processor (e.g., via display driver 105) and having a rectangular screen 106, a memory 108 operatively coupled to the processor, a communication device 110 operatively coupled to the processor, a geographic location sensing device 112 operatively coupled to the processor and a digital camera 114 operatively coupled to the processor. A plurality of digital photos may be stored in the memory 108 of the mobile device 100. The digital photos in the memory 108 may be photos taken using the camera 114 or photos received via the communication device 110 from another device. The geographic location sensing device 112 is preferably a GPS (i.e., global positioning system) device; however, any type of location sensing device may be used, including devices using cellular triangulation, Wi-Fi domain identification, etc., which receive signals that can be used to determine the geographic location of the mobile device 100.

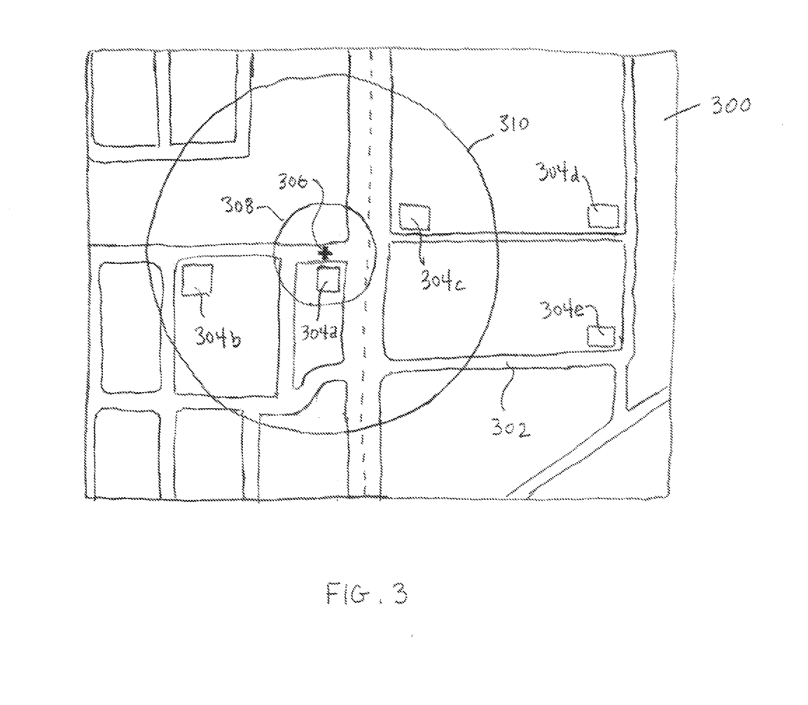

Referring now to FIG. 2a, there is illustrated a template for a photo frame including location sensitive photo commerce in accordance with one embodiment. In the illustrated example, the template 200 is shown displayed on the screen 106 of a mobile device 100. The template 200 includes graphic content 202 that surrounds a reserved space 204 set aside for the user-supplied photo that will be framed by the photo frame. In the illustrated embodiment, the graphic content 202 of the template 200 surrounds the reserved space 204 on all four sides; however, having graphic content on all four sides of the reserved space is not required. In other embodiments, the graphic content 202 of the photo frame template 200 may surround the reserved space 204 on only two or three sides, or even on a single side.

The graphic content 202 of the photo frame template 200 may include preselected thematic elements 205 including, but not limited to, colors, patterns, icons, images and/or wording that relate to a particular theme of interest. In the illustrated example, the photo frame template 200 corresponds to a “birth announcement” theme, and the thematic elements 205 include a border color, polka dots 205a, border piping 205b, and “cloud-shaped” text spaces 205c and 205d. The photo frame template may further include user fields 208 set aside within the graphic content 202 for user customization and/or auto-content fields 210 set aside within the graphic content for content automatically generated by the template building system as further explained below. In the illustrated example, a first user field 208a is provided within the thematic element 205c to allow the user to specify the baby's gender and a second user field 208b is provided within the thematic element 205d to allow the user to specify the baby's name. Also in the illustrated example, a first auto-content field 210a is provided for photo commerce purposes and a second auto-content field 210b is provided for providing a date automatically generated by the template building system.

Referring now to FIG. 2b, there is illustrated a digital photo 212 produced by combining a first (i.e., original) digital photo 214 with the graphic content 202 provided by the photo frame template 200, including user customization fields and auto-content fields generated by the template building system. In the digital photo 212, the content from the first digital photo 214 (in this example, a photo of a newborn baby) has been inserted (i.e., digitally) by the system into the reserved space 204 of the template 200, and the graphic content 202 of the photo frame provided by the template now surrounds the original photo. In addition, the system has inserted user-provided content 216 regarding the baby's gender (i.e., “GIRL” 216a) into the user field 208a and regarding the baby's name (i.e., “OLIVIA EMILY” 216b) into the user field 208b. In addition, the system has inserted location specific photo commerce content 218 (i.e., “County Hosp.” and logo) provided by the template building system into the first auto-content field 210a and inserted an automatically generated content 220 (i.e., date “11 06 2011”) into the second auto-content field 210.

In another aspect of the invention, a dynamic automatic template building system for photo frames and location specific photo commerce may operate as follows. A web form may be used to collects event/location data. Event/location data may include, but is not limited to, name, start date, start time, end date, end time, geographic location, and radius of location coverage. The web form may also be used to specify graphic content for use in the template for the event/location. The graphic content may be provided by the user (e.g., uploaded) via the web form and/or the user may select some or all of the graphic content from a plurality of preselected themes via the web form. After the event/location data and graphic content are specified via the web form, an asset builder system generates one or more photo frame templates using the specified graphic content and parameters (i.e., event/location data). The asset builder system then publishes the photo frame templates to one or more websites, e-commerce sites and/or social media outlets specified by the user and/or the system.

The photo frame templates may be accessed (i.e., from the relevant websites, e-commerce site and/or social media outlet) via software executable on a mobile device 100 as further described herein. Typically, a particular photo frame template may only be accessed and/or used on the mobile device when the mobile device 100 is within the time/date/geographic location/radius parameters specified by the event/location data for that particular template. Once accessed via the software on the mobile device 100, each photo frame template can yield one or more digital photo frames that may be used to produce customized digital photos on a mobile device.

Digital photos produced using the photo frames created by the dynamic automatic template building system may be uploaded by the system to specified websites, e-commerce sites and/or social media outlets. In some embodiments, digital photos produce by the system may be automatically uploaded by the system to one or more websites specified in the event/location data and/or by the system, e.g., a photo gallery site or photo sharing site. In other embodiments, the digital photos produced by the system may be automatically uploaded by the system to one or more e-commerce sites specified by the event/location data and/or by the system where physical prints of the digital photos can be purchased. In still other embodiments, the digital photos produced by the system may be automatically uploaded by the system to one or more social media outlets specified by the event/location data and/or by the system.

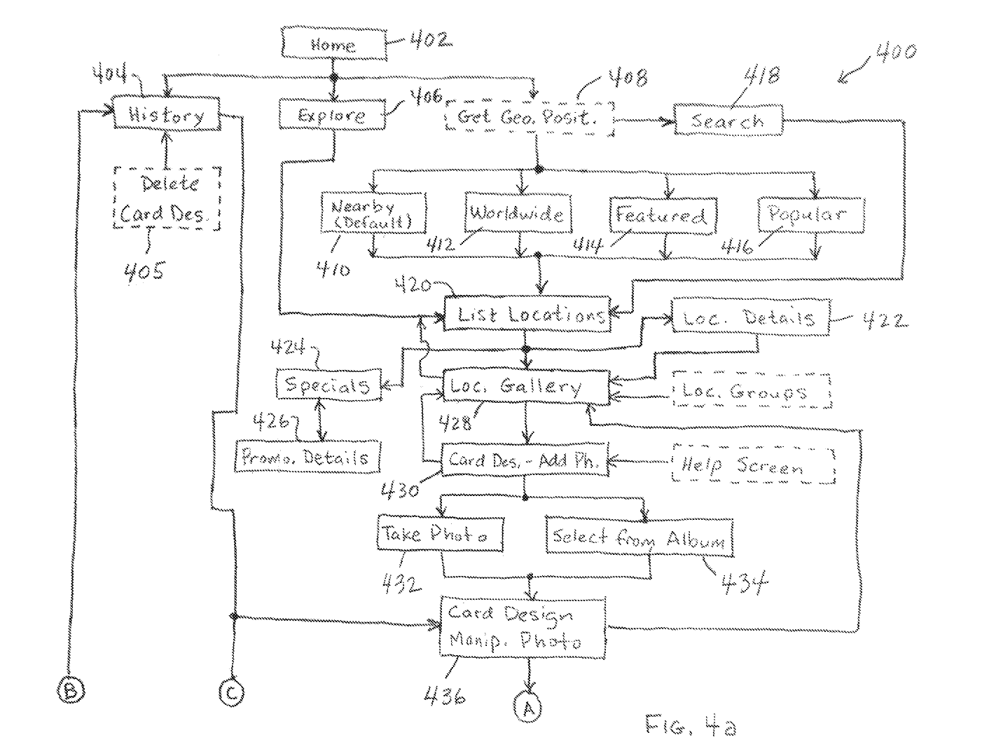

Referring now to FIG. 3, there is illustrated a system and method for dynamic automatic template building and location sensitive photo commerce in accordance with another aspect. Specifically, FIG. 3 shows a map 300 of a geographic area featuring streets 302 and locations 304. The location of a mobile device (e.g., the mobile device 100) as determined by the geographic location sensing device 112 (FIG. 1) is indicated by cross 306. The system software executed on the mobile device 100 may allow a particular photo template to be made available only to mobile devices within a preselected geographic area, for example an area specified in the event/location data. In the illustrated embodiment, for example, the template can be specified to be available: a) within only a set radius; b) within a region; or c) globally. If the “only within a set radius” setting is selected, the template will only be available to a mobile device 100 when the device location 306 is within a pre-specified small radius (denoted by circle 308) of the specified location. In the illustrated case, only photo templates associated with nearby location 304a would be available to the mobile device 100 at location 306 for this setting.

Referring still to FIG. 3, if, however, the “regional” setting is selected, the photo template will be available within a larger radius (denoted by circle 310) of the specified location. In the illustrated case, photo templates associated with locations 304a, 304b and 304c would be available to the mobile device 100 at location 306 for this setting. Finally, if the “global” setting is selected, the photo template will be available to mobile devices at all locations. In the illustrated case, photo templates associated with locations 304a, 304b, 304c, 304d and 304e would be available to the mobile device 100 at location 306 for this setting. It will be appreciated that the exact values for the radii used in various settings may be preselected by the system or selected by the user in various embodiments. Also, as previously described, photo template availability may be restricted by other event/location data settings, e.g., time or date, in addition to geographic location.

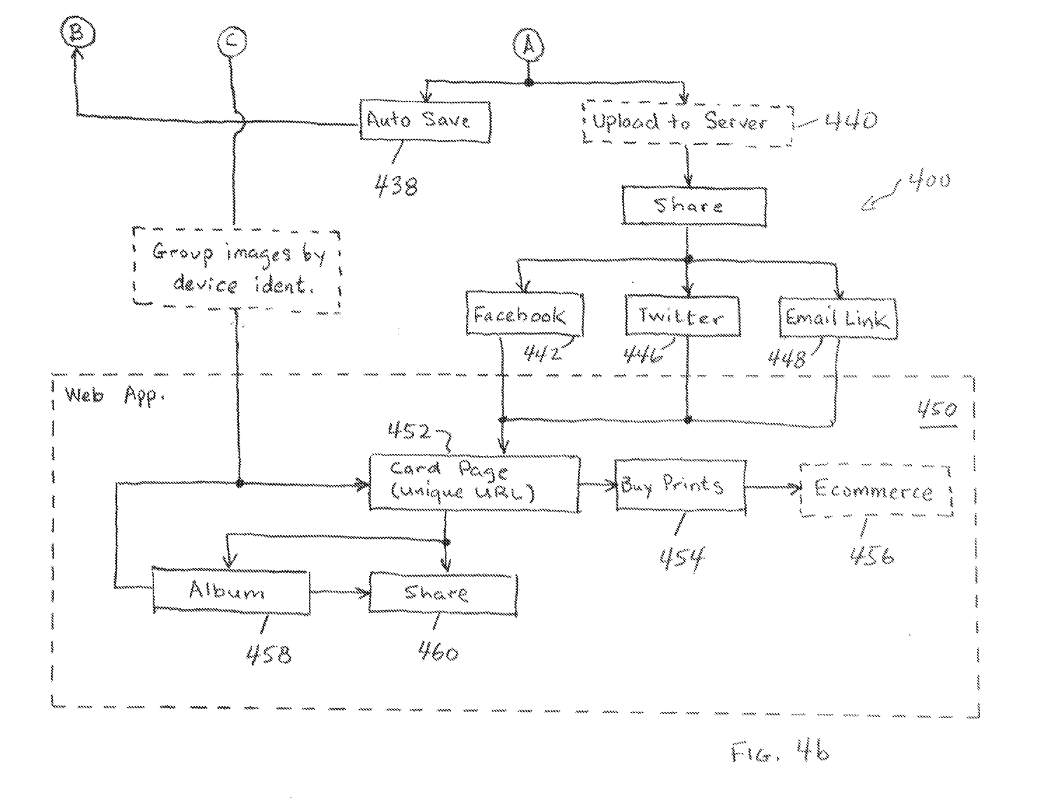

Referring now to FIGS. 4a and 4b, there is shown a system and method 400 for execution on a mobile device (e.g., mobile device 100) for photo frame with dynamic automatic template building system and location sensitive photo commerce in accordance with yet another aspect of the invention. It will be appreciated that FIGS. 4a and 4b represent two portions of a single flowchart, with the connectors denote “A”, “B” and “C” connecting the flow paths between the two portions. The system 400 illustrated in the flowchart represents the functions performed on the mobile device 100 to access a photo template (e.g., template 200) produced by the system from a website or other remote location, generate a photo frame using the template, and produce a new photo (e.g., photo 212) incorporating the photo frame and original user content.

Referring first to FIG. 4a, the system 400 includes a “Home” screen 402 that represents a starting point for the system. From the Home screen 402, the system offers the choice of “History” function 404, “Explore” function 406 or “Get Geographical Position” function 408. The “Get Geographical Position” function 408 utilizes the geographical location sensing device 112 to determine the current location of the mobile device 100, and then offers a choice of available locations (i.e., locations connected to one or more photo templates) categorized into the following groups: “Nearby” 410, “Worldwide” 412, “Featured” 414 and “Popular” 416. Alternatively, from the “Get Geographical Position” function 408, the user may also input a search through a “Search” function 418. Next, a list of locations matching the criteria of functions 410-416 or the search criteria of “Search” 418 is presented as indicated by “List Locations” function 420. Additional information regarding each location in the list 420 may be viewed using the “Location Details” function 422. Information regarding special promotions available at the listed locations can be viewed using the “Specials” function 424, and further details of such promotions and/or coupons and/or discounts may be viewed using the “Promotion Details” function 426.

The “Explore” function 406 provides an alternative method to search for locations associated with photo templates. The “Explore” function 406 allows the user to manually select a distance radius (i.e., from the current geographic location) within which to search for available locations. Locations found using the “Explore” function 406 are listed in the “List Locations” function 420 as previously described.

From the “List Locations” function 420, a “Location Gallery” function 428 may be selected, which provides a visual “thumbnail view” (i.e., a small, reduced resolution view) of the available templates at the selected location. From the “Location Gallery” function 428, the user may select a template (e.g., template 200) from those available in the gallery and move to the “Card Design—Add Photo” function 430, where the user's original digital photo is selected to be combined with the photo frame from the template. Next, if the “Take Photo” function 432 is selected, the user may fill the reserved space 204 (FIG. 2a) of the selected template 200 using a new photo 214 from the camera 114. Alternatively, if the “Select from Album” function 434 is selected, the user may fill the reserved space 204 using an existing photo 214 stored in the memory 108 of the mobile device. Once a photo 214 is chosen using function 432 or 434, the system advances to the “Card Design Manipulate Photo” function 436. This function allows the user to manipulate the user photo 214, e.g., to zoom in or out, to rotate and/or to drag (i.e., translate) so that the user photo is positioned as desired within the photo frame provided by the template 200. This completes the creation of a new digital photo (e.g., photo 212) including content from the original user photo 214 surrounded by the graphic content 202 from the photo frame supplied by the template system.

Continuing to FIG. 4b, after the new digital photo 212 is created, the system automatically saves the photo using the “Auto Save” function 438 to the “History” function 404. All of the user's photos made using the photo frame system are stored in the “History” function 404. These stored photos may be viewed, or sent for additional manipulation (function 436) or deleted using the “Delete Card Design” function 405. At the same time as “Auto Save” function 438, the system may present an “Upload to Server” function 440, which allows the user to automatically “Share” (i.e., upload) the new digital photo 212 to social media sites such as Facebook™ (denoted by 442) and/or Twitter™ (denoted by 446) and/or to Email (denoted by 448).

A further aspect of the invention is a web application 450 that may provide a “Card Page (Unique URL)” function 452 when the new digital photo 212 is shared as described above. The “Card Page” function 452, creates a web page having a unique URL for all photos produced using a particular template. The “Card Page” function 452 may be linked to a “Buy Prints’ function 454 and related E-commerce functions 456 allowing users to view and purchase prints of the photos created using the template system 400. The web application 450 may further provide an “Album” function 458 so that other users of the system (i.e., on other mobile devices) can see photos created by the system, share them (function 460) and buy prints using the “Buy Prints” and Ecommerce functions 454, 456.

It will be appreciated by those skilled in the art having the benefit of this disclosure that this system and method for photo frame with dynamic automatic template building system and location sensitive photo commerce provides a system and method for providing graphic frame content to a mobile device that may be combined with a first digital photo to create a second digital photo that incorporates elements of both the graphic frame and the first digital photo. In particular, it provides a system and method for providing graphic frame content that is automatically customized based on the geographic location of a mobile device. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for execution on a mobile device for photo frames with dynamic automatic template building system and location sensitive photo commerce on the mobile device, the mobile device having a processor, a touchscreen display operatively coupled to the processor, a memory operatively coupled to the processor, a communication device operatively coupled to the processor, a geographic location sensing device operatively coupled to the processor and a digital camera operatively coupled to the processor, the method comprising the following steps:
determining, by a geographic location sensing device operatively coupled to a processor of a mobile device, a first geographic location of the mobile device;
obtaining, by a communication device operatively coupled to the processor, information from an external source regarding templates for photo frames associated with second geographic locations of known proximity to the first geographic location;
downloading, by the communication device, a template for one of the photo frames for which information was received from the external source, the photo frame including a graphic content;
combining, by the processor, the graphic content from the photo frame with additional graphic content from one of
a digital photo stored previously stored in a memory operatively coupled to the processor or
a digital photo taken by a digital camera operatively coupled to the processor;
creating a new digital photo from the combined graphic content from the photo frame and the additional graphic content; and
storing the new digital photo in the memory.

2. A method in accordance with claim 1, wherein the information regarding templates for photo frames associated with second geographic locations is filtered to display only information regarding photo frames associated with second geographic locations within a specified distance of the first geographic location.

3. A method in accordance with claim 2, wherein the user of the mobile device can select the specified distance from a range of distances.

4. A method in accordance with claim 3, wherein the user of the mobile device can select the specified distance from a range of distances using a slider on a touchscreen operatively connected to the processor.

5. A method in accordance with claim 2, wherein the user of the mobile device can select the specified distance from plurality of predetermined distances.

6. A method in accordance with claim 1, wherein the photo frame further comprises user-supplied data added to the graphic content.

7. A method in accordance with claim 1, wherein the photo frame further comprises date information automatically added to the graphic content.

8. A method in accordance with claim 1, wherein the photo frame further comprises location specific photo commerce information added to the graphic content.
